(19) United States
(12) Patent Application Publication
(10) Pub. No.: US 2026/0339772 A1
(43) Pub. Date: Oct. 29, 2026

(54) PROACTIVE APPROACH TO REMEDIATING STATE DRIFTS IN DATA PROCESSING SYSTEMS

(71) Applicant: Dell Products L.P., Round Rock, TX (US)

(72) Inventors: ROMAN BOBER, Ashdod (IL); MAXIM BALIN, Gan-Yavne (IL); NECHAMI MAMAN, Jerusalem (IL)

(21) Appl. No.: 19/190,375

(22) Filed: Apr. 25, 2025

(51) Int. Cl. G06F 11/07

(52) U.S. Cl. CPC G06F 11/0793; G06F 11/0709

(57) ABSTRACT

Methods and systems for managing an operation of a distributed system are disclosed. The operation may be managed by proactively remediating state drifts in data processing systems of the distributed system. To remediate the state drifts, a current state drift may be identified using telemetry data and/or a drift schema, the drift schema based on a blueprint of the distributed system. A future state drift may be identified using telemetry data, the current state drift, and/or a trained machine learning model. A remediation process may be generated using the current state drift and/or the future state drift. The remediation process may be used with the data processing systems to mitigate an impact of the state drifts, thereby facilitating provisioning of desired computer implemented services by the data processing systems.

### FIELD

Embodiments disclosed herein relate generally to managing an operation of a distributed system. More particularly, embodiments disclosed herein relate to proactively remediating state drifts in data processing systems of the distributed system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a distributed system in accordance with an embodiment.

FIGS. 2A-2D show interaction diagrams illustrating operation of a distributed system in accordance with an embodiment.

FIGS. 3A-3B show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing an operation of a distributed system. The operation may be managed by proactively remediating state drifts in data processing systems of the distributed system. The state drifts may be remediated by first receiving telemetry data by a management system from the data processing systems. The telemetry data may be used with a drift schema, based on a blueprint from a client, to identify a current state drift of the state drifts.

The telemetry data and/or the current state drift may be ingested by a trained machine learning model to generate a predicted state drift. The predicted state drift may be used with the drift schema to identify a future state drift of the state drifts.

Using the current state drift and/or the future state drift, a drift notification may be transmitted from the management system to the data processing system and/or the client. Further, a remediation process may be generated by the management system and/or performed on the data processing system to mitigate an impact of the current state drift and/or the future state drift. By performing the remediation process, a provisioning of desired computer implemented services may be facilitated by the distributed system.

In an embodiment, a method for managing an operation of a distributed system is disclosed. The method may include: (i) identifying an occurrence of a drift identification event for a data processing system of the distributed system, (ii) identifying, based on the occurrence and/or using at least telemetry data from the data processing system, a current state of the data processing system, (iii) identifying, using at least the telemetry data and a trained machine learning model, a predicted future state of the data processing system, (iv) performing, using the current state, the predicted future state, a blueprint used to manage the data processing system, and a drift schema, a drift identification process to ascertain whether the data processing system has and/or is likely to suffer a state drift at a future point in time; (v) classifying, in an instance of the performing where the data processing system has or is likely to suffer the state drift and/or using the drift schema, a severity level for the state drift; (vi) selecting, based on at least the severity level, a remediation process to mitigate impacts of the state drift, and/or (vi) performing the remediation process to update operation of the data processing system to manage the impacts of the state drift on an ability of the data processing system to continue to provide desired computer implemented services.

The blueprint may include a set of parameters usable to manage the operation of the data processing system, and the set of the parameters, when used to manage the data processing system, cause the data processing system to provide the desired computer implemented services.

The drift schema may include a classification system for levels of severity of the state drift.

The levels of severity of the state drift may be based on differences between blueprints and states of the data processing systems that are managed using the blueprints.

The set of the parameters may indicate, in part, software to be hosted by the data processing system.

The set of the parameters may indicate, in part, configurations for software to be hosted by the data processing system and/or hardware components of the data processing system.

The classification system may include thresholds for the differences, and a rubric for classifying, based on the thresholds that are exceeded by the differences, the levels of the severity into one selected from a group consisting of (i) a minor configuration drift, (ii) a moderate configuration drift, and/or (iii) a critical configuration drift.

The predicted future state may include at least one selected from a group consisting of (i) performance metrics for the operation of the data processing system during, at least, the future point in the time, (ii) resource utilization during the operation, (iii) a security posture of the data processing system during the operation, (iv) communication capabilities of the data processing system during the operation, and/or (v) a health status of the data processing system during the operation.

Selecting the remediation process may include selecting, using the drift schema, at least one action to perform as part of the remediation process, the drift schema associating different actions with different severity levels of the state drift.

Performing the remediation process may include modifying the operation of the data processing system to reduce the severity level for the state drift.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

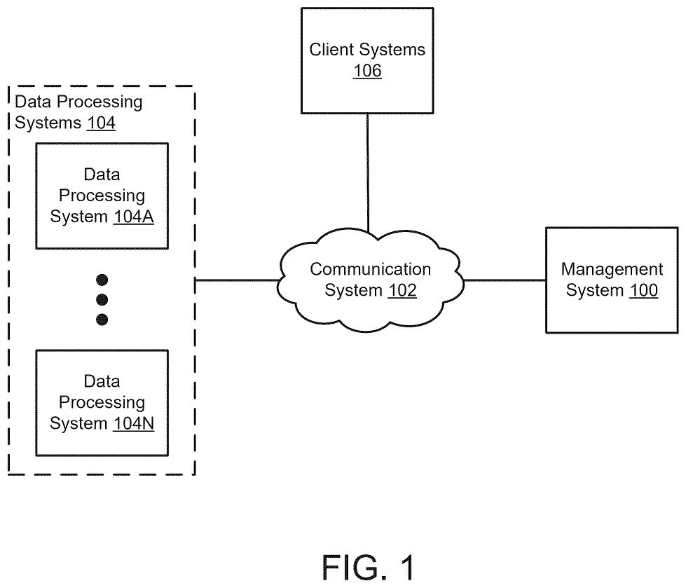

Turning to FIG. 1, a distributed system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a traditional configuration drift detection system may be integrated with the distributed system. The traditional configuration drift detection system may be used to identify and/or address differences between a first configuration of the distributed system and/or a second configuration of the distributed system. The first configuration may include (i) a historical configuration, (ii) a baseline configuration and/or (iii) an intended configuration. The second configuration may include a current configuration and/or a second portion of the second configuration that is different compared to a first portion of the first configuration.

The traditional configuration drift detection system may rely on a reactive approach. The reactive approach may include identifying and/or addressing a configuration drift after the configuration drift has been identified. The traditional configuration drift detection system may rely on administrators of the distributed system to investigate the configuration drift and/or develop remediation plans to mitigate impacts of the configuration drift on the distributed system. The traditional configuration drift detection system may not perform efficiently with larger-scale operations by the distributed system.

However, the reactive approach of the traditional configuration drift detection system may lead to (i) a degradation in the performance of the operations by the distributed system, (ii) security vulnerabilities in the operations of the distributed system and/or (iii) an unintended pause in the operations of the distributed system. The reliance on the administrators (i) may further increase a length of time of the unintended pause in the operations, (ii) may require a significant length of the time to investigate the configuration drift and/or develop the remediation plans, (iii) may lead to inefficient performances of the operations with the larger-scale operations, etc.

Further, the traditional configuration drift detection system may generate numerous notifications. First notifications of the notifications may include first information of critical configuration drifts and/or second notifications of the notifications may include second information of low-level configuration drifts and/or other information. The reliance on the administrators may include manual analyses of the numerous notifications. As a result of manual analyses, any information of the first notifications and/or the second notifications may be omitted because of human error. Thus, utilization of the traditional configuration drift detection system by the distributed system may impact desired computer implemented services.

In general, embodiments disclosed here relate to systems and methods for managing an operation of a distributed system. The operation may be managed by (i) identifying an occurrence of a drift identification event for a data processing system of the distributed system, (ii) identifying, based on the occurrence and/or using at least telemetry data from the data processing system, a current state of the data processing system, (iii) identifying, using at least the telemetry data and a trained machine learning model, a predicted future state of the data processing system, (iv) performing, using the current state, the predicted future state, a blueprint (e.g., parameters) used to manage the data processing system, and a drift schema, a drift identification process to ascertain whether the data processing system has and/or is likely to suffer a state drift at a future point in time, (v) classifying, in an instance of the performing where the data processing system has or is likely to suffer the state drift and/or using the drift schema, a severity level for the state drift, (vi) selecting, based on at least the severity level, a remediation process to mitigate impacts of the state drift, and/or (vii) performing the remediation process to update operation of the data processing system to manage the impacts of the state drift on a capability of the data processing system to continue to provide desired computer implemented services.

The occurrence of the drift identification event may be identified by (i) initializing the distributed system, (ii) receiving telemetry data from the data processing system, (iii) updating software of the data processing system, (iv) changing settings of the data processing system, (v) performing reconfigurations of a network of the distributed system, etc. The drift identification event may include (i) the initialization of the distributed system, (ii) reception of the telemetry data, (iii) at least one change in the settings of the data processing system, etc.

The current state of the data processing system may be identified by (i) receiving, by a management system of the distributed system and from the data processing system, the telemetry data, and/or (ii) aggregating and/or correlating any portion of the telemetry data to obtain the current state of the data processing system.

The any portion of the telemetry data may include (i) first data on software performance, (ii) second data on hardware performance, (iii) third data on system utilization (e.g., (a) computing processing units, (b) memory, (c) network bandwidth, etc.), (iv) fourth data of data pipelines between (a) a first hardware and/or a second hardware, (b) between a first software and/or a second software, and/or (c) between the first hardware and/or the first software, etc. The current state may include at least one condition, based on the any portion of the telemetry data, of an operational status of the distributed system at a present time.

A predicted future state of the data processing system may be identified by (i) ingesting, by the trained machine learning model, the telemetry data and/or (ii) generating, by the trained machine learning model, the predicted future state. The trained machine learning model may include (i) convolutional neural networks (CNNs), (ii) recurrent neural networks (RNNs), (ii) autoencoders, (iv) generative adversarial networks, (v) hybrid neural networks (e.g., CNNs and/or RNNs), etc. The predicted future state may include at least one condition, based on the any portion of the telemetry data, of an operational status of the distributed system at a predicted future time.

The drift identification process may be performed by (i) performing a first comparison of the current state to the parameters to identify a current configurational drift, (ii) performing a second comparison of the current configurational drift to the drift schema to identify a current state drift, (iii) performing a third comparison of the predicted future state to the parameters to identify a predicted future configurational drift, and/or (iv) performing a fourth comparison of the predicted future configurational drift to the drift schema to identify a predicted future state drift. The current state drift may include at least one current configurational drift of the data processing system. The future state drift may include at least one future configurational drift of the data processing system.

The parameters may include (i) data management parameters (e.g., (a) data ingestion rates, (b) formats and/or structures of incoming data, and/or (c) repository types and/or repository capacities), (ii) resource allocation parameters (e.g., (a) CPU processing, (b) memory processing limits, (c) storage quotas for data processing systems, and/or (d) network bandwidth allocation limits), (iii) security parameters (e.g., (a) authentication protocols, (b) concurrency levels for processing tasks, and/or (c) task scheduling priorities), (iv) monitoring parameters (e.g., (a) performance metrics to monitor, (b) retention policies, and/or (c) performance thresholds for corrective actions), etc.

The drift schema may include a classification systems for levels of severity of state drifts. The classification system may be based on thresholds for differences in values of the parameters. The state drifts may include the current state drift and/or the predicted future state drift. The current state drift may include at least one first identification of at least one first parameter for which a first value of the first parameter currently exceeds a first threshold of the thresholds. The predicted future state drift may include at least one second identification of at least one second parameter for which a second value of the second parameter currently exceeds a second threshold of the thresholds.

A severity level for the state drift may be classified by comparing a first magnitude of the current state drift and/or a second magnitude of the predicted future state drift to the classification system of the drift schema to obtain the level of severity of the current state drift and/or predicted future state drift. The first magnitude may include by how much the first value exceeds the first threshold to obtain a first difference. Based on the first difference, the first level of the severity may be categorized as (i) a first minor configuration drift, (ii) a first moderate configuration drift, and/or (iii) a first critical configuration drift. Similarly, the second magnitude may include by how much the second value exceeds the second threshold to obtain a second difference. Based on the second difference, the second level of the severity may be categorized as (i) a second minor configuration drift, (ii) a second moderate configuration drift, and/or (iii) a second critical configuration drift.

The remediation process may be selected, using the drift schema, the first level of the severity, and/or the second level of the severity, by obtaining from a repository at least one task depending on the first level of the severity and/or the second level of the severity. The repository may include (i) definitions of the at least one task, (ii) playbooks that include the at least one task, (iii) historical records of the at least one task that have been previously run, etc. The at least one task may be associated with the first level of the severity, and/or the second level of the severity by (i) a monitoring tool, (ii) a configuration management tool, and/or (iii) a log analysis tool.

The remediation process may be performed by performing, by the management system and/or the data processing system, the at least one task of the remediation process. The at least one task may be assigned by the management system to the data processing system. The data processing system may perform the at least one task. The monitoring system may monitor the performance of the at least one task. In the performance of the at least one task, any issues and/or any errors may be addressed by either the management system and/or the data processing system. Once the at least one task is completed, the management system may validate results of the at least one task and/or verify an outcome of the at least one task is an expected outcome. The results and/or the outcome may be transmitted to the trained machine learning model for further training of the trained machine learning model.

By completing the remediation process, the impact of the state drift on the data processing system may be managed. By managing the impact of the state drift, the data processing system may continue to provide desired computer implemented services.

To provide the above noted functionality, the system may include a management system (e.g., 100), data processing systems (e.g., 104), and/or client systems (e.g., 106). Each of these components is discussed below.

The management system (e.g., 100) may monitor performance of the data processing systems (e.g., 104). The management system may monitor the performance using (i) a drift configuration manager, (ii) a drift detection engine, (iii) a machine learning engine, and/or (iv) a drift notification system. The drift configuration manager may receive parameters from the client systems (e.g., 106) and/or may deploy the parameters. The parameters may be deployed by integrating the parameters the drift configuration manager and/or the drift detection engine, as well as updating, using the parameters, operation of any number of the data processing systems (e.g., 104A-104N).

A drift schema may be generated by the drift configuration manager and/or transmitted by the drift configuration manager to the drift detection engine. The drift detection engine may ingest the drift schema to establish classification systems for levels of severity of state drifts by the any number of the data processing systems (e.g., 104A-104N).

The machine learning engine may select a trained machine learning model from a data processing system (e.g., 104A) and/or integrate the trained machine learning model with the machine learning engine. The trained machine learning model may be selected based on (i) a type of the trained machine learning model and/or (ii) training of the trained machine learning model. The trained machine learning model may be integrated by (i) obtaining the trained machine learning model from the data processing system (e.g., 104A), and/or (ii) registering the trained machine learning model with the machine learning engine to enable ingestion of telemetry data by the trained machine learning model.

Upon ingestion of telemetry data by the drift detection engine, once a state drift in a configuration of the any number of the data processing systems (e.g., 104B-104N) has been identified, the drift detection engine may transmit at least the levels of the severity of the state drifts and/or any other information about the state drifts to the drift notification system. The drift notification system may transmit notifications about the state drifts to the any number of the data processing systems (e.g., 104B-104N). Further, the drift notification system may transmit the notifications about the state drifts to the client systems (e.g., 106) to notify any clients of the distributed system.

The drift detection engine may use at least the state drifts to identify a remediation process. The remediation process may be transmitted by the drift detection engine to the any number of the data processing systems (e.g., 104B-104N) for performance of at least one task of the remediation process by the any number of the data processing systems (e.g., 104A-104N).

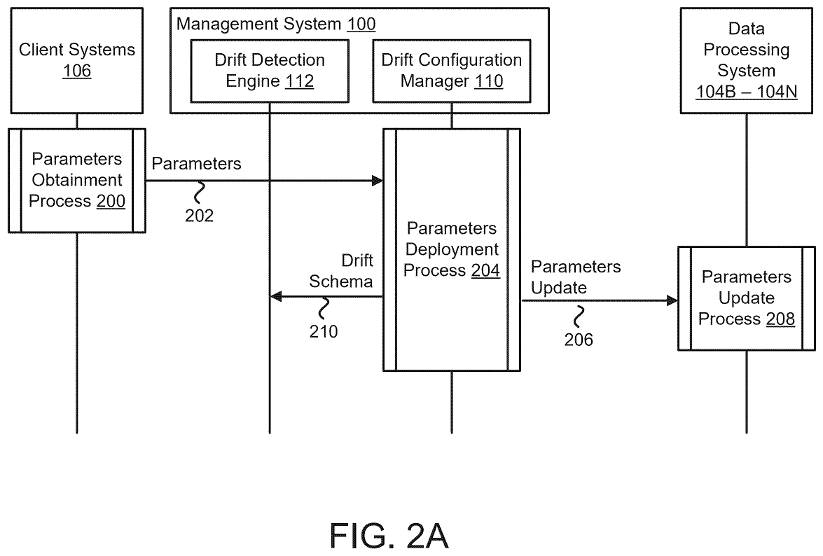

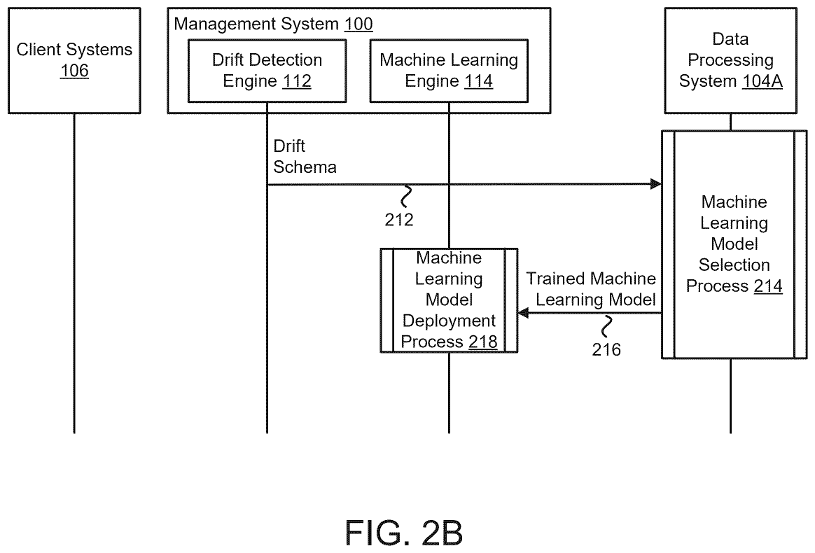

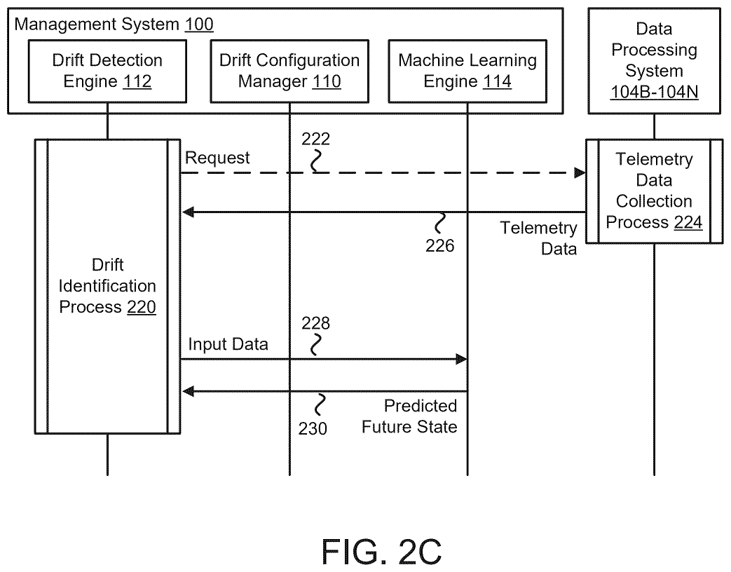

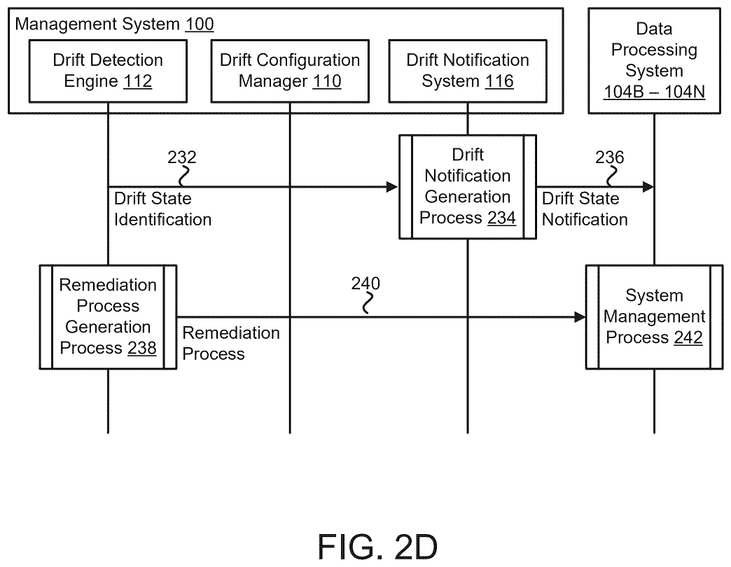

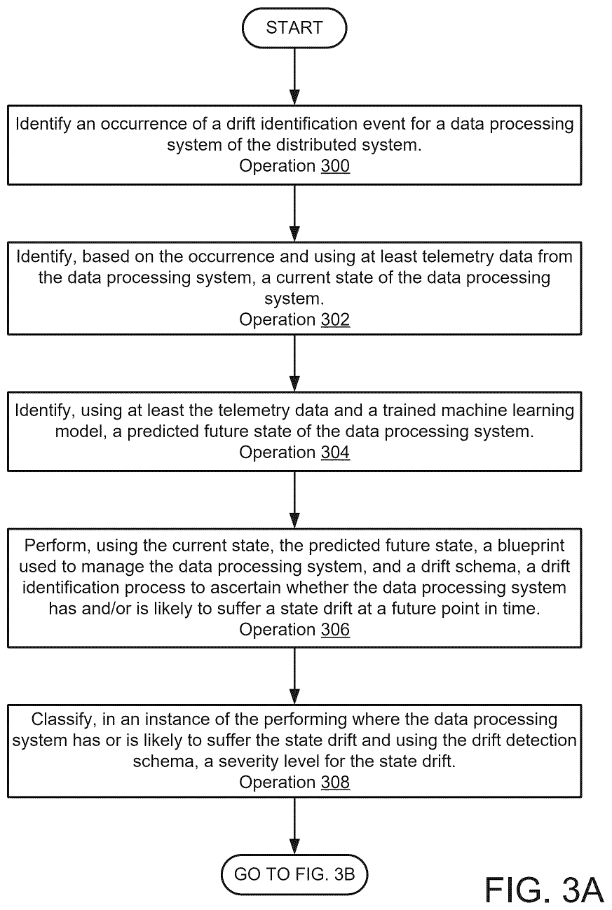

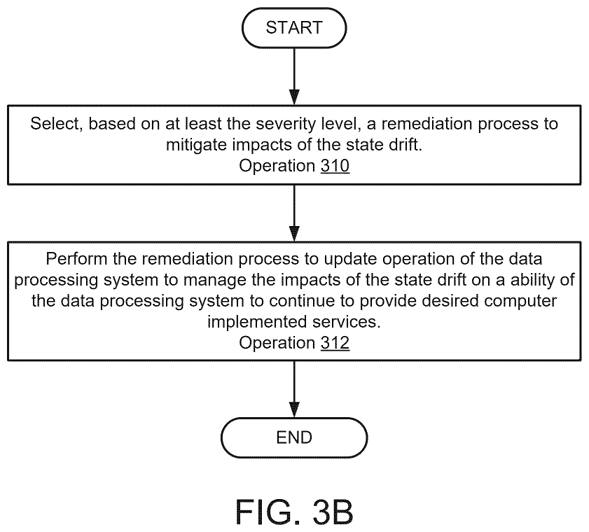

While providing their functionality, any of the management system (e.g., 100), the data processing systems (e.g., 104), and/or the client systems (e.g., 106) may perform all, or a portion, of the flows and methods shown in FIGS. 2A-3B.

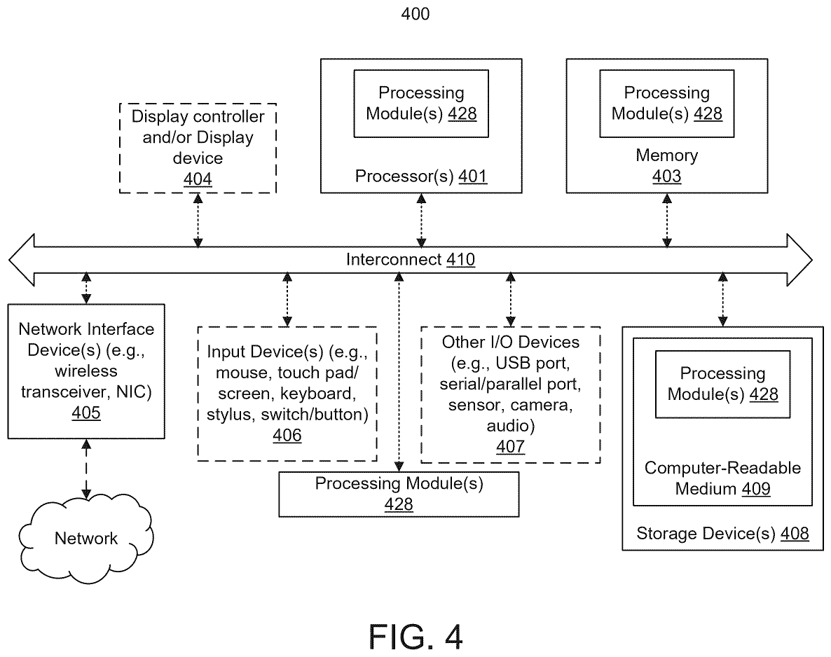

Any of (and/or components thereof) the management system (e.g., 100), the data processing systems (e.g., 104), and/or the client systems (e.g., 106) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, interactions diagrams in accordance with an embodiment are shown in FIGS. 2A-2D. These interactions diagrams may illustrate how data may be obtained and used within the system of FIG. 2A-2D.

In the interaction diagrams, processes performed by and interactions between components of a system in accordance with an embodiment are shown. In the diagrams, components of the system are illustrated using a first set of shapes (e.g., 100, 106, etc.), located towards the top of each figure. Lines descend from these shapes. Processes performed by the components of the system are illustrated using a second set of shapes (e.g., 200, 204, etc.) superimposed over these lines. Interactions (e.g., communication, data transmissions, etc.) between the components of the system are illustrated using a third set of shapes (e.g., 202, 206, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 210. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate data used in and data processing performed in performing a parameters update process (e.g., 208) and/or transmitting a drift schema (e.g., 210).

To perform the parameters update process (e.g., 208) and/or transmit the drift schema (e.g., 210), a parameters update process (e.g., 200) may be performed. During the parameters obtainment process (e.g., 200), parameters (e.g., 202) may be obtained by a client (e.g., 106). The parameters (e.g., 202) may be obtained by generating, by the client (e.g., 106), the parameters (e.g., 202), based on technical requirements and/or functional requirements of a data processing system (e.g., 104B-104N) that use and/or have (i) existing data sources, (ii) workflows, (iii) security requirements, (iv) scalability requirements, (v) project requirements, and/or (vi) any other (a) data sources, (b) flows, (c) requirements.

The parameters (e.g., 202) may be transmitted to a drift configuration manager (e.g., 110) of a management system (e.g., 100) of the distributed system. The parameters (e.g., 200) may be transmitted using (i) a data stream, (ii) shared memory, (iii) message queues, etc. The parameters may include (i) data management parameters (e.g., (a) data ingestion rates, (b) formats and/or structures of incoming data, and/or (c) repository types and/or repository capacities), (ii) resource allocation parameters (e.g., (a) CPU processing, (b) memory processing limits, (c) storage quotas for data processing systems, and/or (d) network bandwidth allocation limits), (iii) security parameters (e.g., (a) authentication protocols, (b) concurrency levels for processing tasks, and/or (c) task scheduling priorities), (iv) monitoring parameters (e.g., (a) performance metrics to monitor, (b) retention policies, and/or (c) performance thresholds for corrective actions), etc.

Once the parameters (e.g., 202) have been received, a parameters deployment process (e.g., 204) may be performed. During the parameters deployment process (e.g., 204), the drift configuration manager (e.g., 110) may (i) parse the parameters (e.g., 202), (ii) validate the parameters (e.g., 202), and/or (iii) use the parameters (e.g., 202) to generate and/or populate configurations of the distributed system.

The parameters (e.g., 202) may be validated by confirming that a format, syntax and/or compatibility of the parameters (e.g., 202) are compatible with the configurations and/or operation of the distributed system. The configurations may be generated and/or may be populated using the parameters (e.g., 202). The parameters (e.g., 202) may include (i) resource allocation limits, (ii) environment variables, (iii) workflow definitions, (iv) encryption configurations, (v) dependency management configurations, (v) external application programming interface (API) endpoints, etc. Also, an orchestration platform (e.g., (i) Kubernetes, (ii) Apache, (iii) Mesos, and/or (iv) any other orchestration platform) may be updated by ingesting, by the orchestration platform, the parameters (e.g., 202) to enable the operation of the orchestration platform by the drift configuration manager (e.g., 110).

Further, a drift schema (e.g., 210) may be generated during the parameters deployment process (e.g., 204). The drift schema (e.g., 210) may include a classification systems for levels of severity of state drifts by the data processing systems (e.g., 104B-104N). The classification system may be based on thresholds for differences in values of the parameters from the data processing system (e.g., 104B-104N) compared to baseline values recorded by the management system (e.g., 100) in the parameters deployment process (e.g., 204).

The drift schema may be transmitted to a drift detection engine (e.g., 112) of the management system (e.g., 100). The drift schema may be transmitted using (i) the data stream, (ii) the shared memory, (iii) the message queues, etc. The drift detection engine (e.g., 112) may use the drift schema (e.g., 210) while performing monitoring of the data processing system (e.g., 104B-104N) to detect the state drifts.

During the parameters deployment process (e.g., 204), a first portion of the parameters (e.g., 206) may be transmitted to the data processing system (e.g., 104B-104N). The first portion may be transmitted using (i) the data stream, (ii) the shared memory, (iii) the message queues, etc.

Once the first portion of the parameters (e.g., 206) has been received by the data processing system (e.g., 104B-104N), a parameters update process (e.g., 208) may be performed. During the parameters update process (e.g., 208), the data processing system (e.g., 104B-104N) may ingest the first portion of the parameters (e.g., 206) to configure the data processing system (e.g., 104B-104N). By configuring using the first portion of the parameters (e.g., 206), the data processing system (e.g., 104B-104N) may use the first portion of the parameters (e.g., 206) to (i) configure local environment variables, (ii) perform tasks in the operation of the data processing system (e.g., 104B-104N), (iii) establish communication with other data processing systems (e.g., 104B-104N), (iv) monitor performance of the data processing system (e.g., 104B-104N), (v) adapt operational settings to workload changes, (vi) store data, (vii) retrieve the data, (viii) process the data, etc.

Thus, via the first interaction illustrated in FIG. 2A, a system in accordance with an embodiment may perform the parameters update process (e.g., 208) and/or transmit the drift schema (e.g., 210). Consequently, the distributed system may be more likely to be able to provide desired computer implemented services by configuring the data processing system (e.g., 104B-104N) based on the parameters (e.g., 206) and/or configuring the management system (e.g., 100) to perform identifications of state drifts in the data processing system (e.g., 104B-104N).

Turning to FIG. 2B, a second interaction diagram in accordance with an embodiment is shown. The second interaction diagram may illustrate data used in and data processing performed in deploying (e.g., 218) a trained machine learning model (e.g., 216) for generating predicted future states of the data processing system (e.g., 104B-104N).

To deploy (e.g., 218) a trained machine learning model (e.g., 216), a machine learning model selection process (e.g., 214) may be performed. During the machine learning model selection process (e.g., 214), a drift schema (e.g., 212) may be transmitted from a drift detection engine (e.g., 112) to a data processing system (e.g., 104A). The drift schema (e.g., 212) may be transmitted using (i) a data stream, (ii) shared memory, (iii) message queues, etc. The drift schema (e.g., 212) may be similar to the drift schema (e.g., 210) that is detailed in the description of FIG. 2A.

Once the drift schema (e.g., 212) has been received by the data processing system (e.g., 104A), a trained machine learning model (e.g., 216) may be selected using the drift schema (e.g., 212) and/or from a repository of the data processing system (e.g., 104A). The trained machine learning model (e.g., 216) may be selected by (i) analyzing the drift schema (e.g., 212), (ii) select the trained machine learning model that can read data corresponding to the drift schema (e.g., 212) and/or that is compatible with a machine learning engine (e.g., 114) of the management system.

The drift schema (e.g., 212) may be analyzed, by the data processing system (e.g., 104), by (i) identifying types of data (e.g., (a) numerical, (b) categorical, (c) text string, and/or (d) image-based), (ii) identifying a goal (e.g., drift detection) of a drift detection engine (e.g., 112) that may utilize the drift schema (e.g., 212), and/or (iii) identify at least one output expected from the trained machine learning model (e.g., 216)

Based on the analysis of the drift schema (e.g., 212), the trained machine learning model (e.g., 216) may be selected. The trained machine learning model may include (i) convolutional neural networks (CNNs), (ii) recurrent neural networks (RNNs), (ii) autoencoders, (iv) generative adversarial networks, (v) hybrid neural networks (e.g., CNNs and/or RNNs), etc.

Compatibility of the trained machine learning model (e.g., 216) with the machine learning engine (e.g., 114) may be determined by (i) determining whether a first export format (e.g., (a) ONYX, (b) SavedModel, (c) Pickle, and/or (d) any other first export format) of the machine learning engine (e.g., 114) is compatible with a second export format of the trained machine learning model (e.g., 216), (ii) determining whether the trained machine learning model (e.g., 216) is compatible with a first framework (e.g., (a) TensorFlow, (b) PyTorch, (c) scikit-learn and/or (d) any other first framework) of the machine learning engine (e.g., 114), (iii) determining whether first computational requirements (e.g., (a) CPU requirements, (b) memory requirements, (c) any other first computational requirements) of the machine learning engine (e.g., 114) are fulfilled by the trained machine learning model (e.g., 216), etc.

Once selected by the data processing system (e.g., 104A), the trained machine learning model (e.g., 216) may be transmitted to the machine learning engine (e.g., 114). The trained machine learning model (e.g., 216) may be transmitted using (i) the data stream, (ii) the shared memory, (iii) the message queues, etc.

Once the machine learning engine (e.g., 114) receives the trained machine learning model (e.g., 216), a machine learning model deployment process (e.g., 218) may be performed. During the machine learning model deployment processes (e.g., 218), the trained machine learning model (e.g., 216) may be configured with the machine learning model engine (e.g., 114). To configure the trained machine learning model (e.g., 216), the trained machine learning model (e.g., 216) may be first added to a registry of the machine learning engine (e.g., 114). Then, to use the trained machine learning model (e.g., 216) by the machine learning engine (e.g., 114), (i) computational resources may be allocated to the trained machine learning model (e.g., 216), (ii) variables (e.g., (a) runtime settings, (b) dependencies, and/or (c) input-output schemas) may be defined, and/or (iii) scaling policies may be defined to enable efficient handling of different workloads by the trained machine learning model (e.g., 216).

Then, the trained machine learning model (e.g., 216) may be deployed in, for example, a container of a software framework (e.g., Docker and/or any other software framework). Also, as least one endpoint of the trained machine learning model (e.g., 216) to an application programming interface (API) interface may be defined. The at least one endpoint may enable first transmission of input data (e.g., 228) from the API to the trained machine learning model (e.g., 216) and/or second transmission of output data of the trained machine learning model (e.g., 216) to the API.

Thus, via the second interaction illustrated in FIG. 2B, a system in accordance with an embodiment may deploy (e.g., 218) a trained machine learning model (e.g., 216) to the machine learning engine (e.g., 114). Consequently, the management system (e.g., 100) may be more likely to be able to provide desired computer implemented services by enabling utilization, by the machine learning engine (e.g., 114), of the trained machine learning model (e.g., 216).

Turning to FIG. 2C, a third interaction diagram in accordance with an embodiment is shown. The third interaction diagram may illustrate data used in and data processing performed in performing a drift identification process (e.g., 220) using telemetry data (e.g., 226) of the data processing system (e.g., 104B-104N) to identify drift states.

During the drift identification process (e.g., 220), a request (e.g., 222) may be transmitted from a drift detection engine (e.g., 112) to a data processing system (e.g., 104B-104N). The request (e.g., 222) may be transmitted using (i) a data stream, (ii) shared memory, (iii) message queues, etc. The request (e.g., 222) may be received by the data processing system (e.g., 104B-104N) and/or ingested in a telemetry data collection process (e.g., 224).

During the telemetry data collection process (e.g., 224), telemetry data (e.g., 226) may be obtained from the data processing system (e.g., 104B-104N). The telemetry data (e.g., 226) may be obtained by collecting the telemetry data (e.g., 226) from the data processing system (e.g., 104B-104N). The telemetry data (e.g., 226) may be collected using (i) a telemetry framework, (ii) monitoring tools, (iii) sensors, (iv) agents, etc. of the data processing system (e.g., 104B-104N). The telemetry data (e.g., 226) may be transmitted using (i) the data stream, (ii) the shared memory, (iii) the message queues, etc.

The telemetry data (e.g., 226) may be transmitted from the data processing system (e.g., 104B-104N) to the drift detection engine (e.g., 112). Any portion of the telemetry data (e.g., 226) may include (i) first data on software performance, (ii) second data on hardware performance, (iii) third data on system utilization (e.g., (a) computing processing units, (b) memory, (c) network bandwidth, etc.), (iv) fourth data of data pipelines between (a) a first hardware and/or a second hardware, (b) between a first software and/or a second software, and/or (c) between the first hardware and/or the first software, etc.

The drift detection engine (e.g., 112) may receive the telemetry data (e.g., 226). Using the telemetry data (e.g., 226), the drift detection engine (e.g., 112) may determine a current state of the data processing system (e.g., 104B-104N). The drift detection engine (e.g., 112) may determine the current state by aggregating and/or correlating the any portion of the telemetry data (e.g., 226) to obtain the current state of the data processing system (e.g., 104B-104N).

The any portion of the telemetry data (e.g., 226) may be aggregated by generating at least one summary (e.g., (i) error rates, (ii) task completion progressions, (iii) latency, and/or (iv) any other summary) from the any portion. The any portion of the telemetry data (e.g., 226) may be correlated by linking events between data processing systems (e.g., 104B-104N) to track a flow of operations by the data processing systems (e.g., 104B-104N). The at least one summary, the events, and/or the flow of the operations may be used to (i) generate health statuses, (ii) determine bottlenecks in the operations, (iii) detect anomalies in the operations, etc. to generate first characteristics of the current state of the data processing system (e.g., 104B-104N).

Using the first characteristics of the current state and/or a drift schema (e.g., 210 of FIGS. 2A and/or 212 of FIG. 2B), a current state drift may be identified. The current state drift may be identified by (i) performing a first comparison of the first characteristics of the current state to parameters (e.g., 202, described in FIG. 2A) to identify a current configurational drift, (ii) performing a second comparison of the current configurational drift to the drift schema (e.g., 210 and/or 212) to identify a current state drift. The first comparison may be performed by (i) identifying first differences between current state parameters of the data processing system (e.g., 104B-104N) and/or the parameters (e.g., 202) to generate the current configurational drift, (ii) measuring first magnitudes of the first differences of the current configurational drift, and/or (iii) identifying whether the first magnitudes exceed first thresholds of the drift schema (e.g., 210 and/or 212). The current state drift may be identified by the drift detection engine (e.g., 112) by determining whether the first magnitudes of the first differences of the current configurational drift exceed thresholds of the drift schema (e.g., 210 and/or 212).

In addition, during drift identification process (e.g., 220), second characteristics of a predicted future state of the data processing system (e.g., 104B-104N) may be identified. The second characteristics of the predicted future state may be identified by (i) transmitting input data (e.g., 228) of the drift detection engine (e.g., 112) to a machine learning engine (e.g., 114), (ii) ingesting, by the machine learning engine (e.g., 114), the input data (e.g., 228) to identify second characteristics of the predicted future state (e.g., 230), and/or (iii) receiving, from the machine learning engine (e.g., 114) and/or by the drift detection engine (e.g., 112), the second characteristics of the predicted future state (e.g., 230).

The input data (e.g., 228) may include the any portion of the telemetry data (e.g., 226) and/or the current state drift. The input data (e.g., 228) may be transmitted using (i) the data stream, (ii) the shared memory, (iii) the message queues, etc.

The machine learning engine (e.g., 114) may transmit the input data (e.g., 228) to the trained machine learning model (e.g., 216, from FIG. 2B). The trained machine learning model (e.g., 216) may be assigned a task of (i) ingesting the input data (e.g., 228) and/or (ii) identifying, using the input data (e.g., 228), the second characteristics of the future state of the data processing system (e.g., 104B-104N). The second characteristics may include (i) future health statuses, (ii) future bottlenecks in the operations, (iii) future anomalies in the operations, etc. The second characteristics of the future state may be transmitted using (i) the data stream, (ii) the shared memory, (iii) the message queues, etc.

During drift identification process (e.g., 220), the drift detection engine (e.g., 112) may receive the second characteristics of the future state from the machine learning engine (e.g., 114). Using the second characteristics of the predicted future state (e.g., 230) and/or a drift schema (i.e., 210), a predicted future state drift may be identified. The predicted future state drift may be identified by (i) performing a third comparison of the second characteristics of the predicted future state (e.g., 230) to the parameters (e.g., 202) to identify a predicted future configurational drift, (ii) performing a fourth comparison of the predicted future configurational drift to the drift schema (e.g., 210 and/or 212) to identify the predicted future state drift.

The third comparison may be performed by (i) identifying second differences between predicted future state parameters of the data processing system (e.g., 104B-104N) and/or the parameters (e.g., 202) to generate the predicted future configurational drift, (ii) measuring second magnitudes of the second differences of the predicted future configurational drift, and/or (iii) identifying whether the second magnitudes exceed the thresholds of the drift schema (e.g., 210 and/or 212). The predicted future state drift may be identified by the drift detection engine (e.g., 112) by determining whether the second magnitudes of the second differences of the predicted future configurational drift exceed the thresholds of the drift schema (e.g., 210 and/or 212).

Thus, via the third interaction illustrated in FIG. 2C, a system in accordance with an embodiment may perform the drift identification process (e.g., 220). Consequently, the management system (e.g., 100) may be more likely to be able to provide desired computer implemented services by detecting whether a current state drift of the data processing system (e.g., 104B-104N) and/or a predicted future state drift of the data processing system (e.g., 104B-104N) has been identified.

Turning to FIG. 2D, a fourth interaction diagram in accordance with an embodiment is shown. The fourth interaction diagram may illustrate data used in and data processing performed in performing a system management process (e.g., 242).

To perform the system management process (e.g., 242), a drift notification generation process (e.g., 234) may be performed. During the drift notification generation process (e.g., 234), a drift state identification (e.g. 232) may be transmitted to a drift notification system (e.g., 116) of a management system (e.g., 100). The drift state identification (e.g. 232) may be transmitted by using (i) a data stream, (ii) shared memory, (iii) message queues, etc. The drift state identification (e.g., 232) may include a categorized severity level for a current state drift and/or a predicted future state drift of the data processing system (e.g., 104B-104N). The categorized severity level may include (i) a minor configuration drift, (ii) a moderate configuration drift, and/or (iii) a critical configuration drift.

A drift notification system (e.g., 116) may receive the drift state identification (e.g. 232). Using the drift state identification (e.g. 232), a drift notification generation process (e.g., 234) may be performed. During the drift notification generation process (e.g., 234), a drift state notification (e.g., 236) may be generated. The drift state notification may include (i) the categorized severity level, (ii) a first identification of the data processing system (e.g., 104B-104N) on which the current state drift has occurred and/or predicted future state drift is likely to occur, (iii) a second identification of operations that are affected, (iv) a third identification of client systems (e.g., 106) to which the drift state notification (e.g., 236) may be further transmitted, etc. The drift state notification (e.g. 236) may be transmitted by using (i) the data stream, (ii) the shared memory, (iii) the message queues, etc.

Once the drift state notification (e.g. 236) may be transmitted, a remediation process generation process (e.g., 238) may be performed. During the remediation process generation process (e.g., 238), a remediation process (e.g., 240) may be generated. The remediation process (e.g., 240) may be generated by modifying the operations of the data processing system (e.g., 104B-104N) to reduce the categorized severity level.

The operations may be modified by (i) using new data formats for processing data, (ii) applying new validation rules for the data, (iii) adding new metadata to the data to perform data enrichment, (iv) pruning data of datasets to enhance processing speeds, (v) performing data cleanup (e.g., (a) remove data errors, (b) remove duplicate data, (c) modify missing values in the data, and/or (d) perform any other data cleanup), (vi) reallocating computational resources (e.g., CPU, memory, network bandwidth, and/or any other computational resources) of the data processing system (e.g., 104B-104N), (vii) prioritizing critical operations of the data processing system (e.g., 104B-104N), (viii) adjusting communication protocols between the data processing system (e.g., 104B-104N) to reduce latency and/or improve reliability of the operations, (xi) enhancing system redundancy, etc.

The remediation process (e.g. 240) may be transmitted to the data processing system (e.g., 104B-104N) using (i) the data stream, (ii) the shared memory, (iii) the message queues, etc. Once the data processing system (e.g., 104B-104N) has received the remediation process (e.g., 240), the system management process (e.g., 242) may be performed. During the system management process (e.g., 242), at least one task of the remediation process (e.g., 240) may be performed to modify the operations of the data processing system (e.g., 104B-104N). The at least one task may be performed by (i) assigning the at least one task to a task queue of the data processing system (e.g., 104B-104N), (ii) selecting, by the data processing system (e.g., 104B-104N), the at least one task in the task queue, and/or (iii) performing, by the data processing system (e.g., 104B-104N), the at least one task to modify the operations.

Thus, via the fourth interaction illustrated in FIG. 2D, a system in accordance with an embodiment may perform the system management process (e.g., 242). Consequently, the management system (e.g., 100) and/or the data processing system (e.g., 104B-104N) may be more likely to be able to provide desired computer implemented services by performing the remediation process (e.g., 240) to mitigate an impact and/or reduce the categorized severity level of the current state drift and/or the predicted future state drift.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage an operation of a distributed system. FIGS. 3A-3B illustrate a method that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing an operation of a distributed system in accordance with an embodiment is shown. The method may be performed, for example, by any of the components of the system of FIG. 1, and/or other components not shown therein.

At operation 300, an occurrence of a drift identification event may be identified for a data processing system of the distributed system. The occurrence of a drift identification event may be identified by (i) initializing the distributed system, (ii) receiving telemetry data from the data processing system, (iii) updating software of the data processing system, (iv) changing settings of the data processing system, (v) performing reconfigurations of a network of the distributed system, etc. The drift identification event may include (i) the initialization of the distributed system, (ii) reception of the telemetry data, (iii) at least one change in the settings of the data processing system, etc.

At operation 302, a current state of the data processing system may be identified, based on the occurrence and using at least telemetry data from the data processing system. The current state may be identified by (i) receiving, by a management system of the distributed system and/or from the data processing system, the telemetry data, and/or (ii) using any portion of the telemetry data to obtain the current state of the data processing system.

The any portion of the telemetry data may include (i) first data on software performance, (ii) second data on hardware performance, (iii) third data on system utilization (e.g., (a) computing processing units, (b) memory, (c) network bandwidth, etc.), (iv) fourth data of data pipelines between (a) a first hardware and/or a second hardware, (b) between a first software and/or a second software, and/or (c) between the first hardware and/or the first software, etc. The current state may include at least one condition, based on the any portion of the telemetry data, of a first operational status of the distributed system at a present time.

At operation 304, a predicted future state of the data processing system may be identified using at least the telemetry data and a trained machine learning model. The predicted future state may be identified (i) ingesting, by a trained machine learning model, the telemetry data and/or (ii) generating, by the trained machine learning model, the predicted future state. The trained machine learning model may include (i) convolutional neural networks (CNNs), (ii) recurrent neural networks (RNNs), (ii) autoencoders, (iv) generative adversarial networks, (v) hybrid neural networks (e.g., CNNs and/or RNNs), etc. The predicted future state may include the at least one condition, based on the any portion of the telemetry data, of a second operational status of the distributed system at a predicted future time.

At operation 306, a drift identification process may be performed, using the current state, the predicted future state, a blueprint used to manage the data processing system, and a drift schema, to ascertain whether the data processing system has and/or is likely to suffer a state drift at a future point in time. The drift identification process may be performed by (i) performing a first comparison of the current state to the parameters to identify a current configurational drift, (ii) performing a second comparison of the current configurational drift to the drift schema to identify a current state drift, (iii) performing a third comparison of the predicted future state to the parameters to identify a predicted future configurational drift, and/or (iv) performing a fourth comparison of the predicted future configurational drift to the drift schema to identify a predicted future state drift.

At operation 308, a severity level for the state drift may be classified in an instance of the performing where the data processing system has or is likely to suffer the state drift and using the drift detection schema. The severity level for the state drift may be classified by comparing a first magnitude of the current state drift and/or a second magnitude of the predicted future state drift to the classification system of the drift schema to obtain the level of severity of the current state drift and/or predicted future state drift.

Continuing on to FIG. 3B, at operation 310, a remediation process may be selected, based on at least the severity level, to mitigate impacts of the state drift. The remediation process may be selected by (i) selecting, using the drift schema, at least one action to perform as part of the remediation process, the drift schema associating different actions with different severity levels of state drifts. The at least one action may be selected by (i) selecting the at least one action from a repository, (ii) generating the at least one action based on the severity level, etc.

At operation 312, the remediation process to update operation of the data processing system may be performed to manage the impacts of the state drift on an ability of the data processing system to continue to provide desired computer implemented services. The remediation process may be performed by modifying operation of the data processing system to reduce the severity level for the state drift. The operation may be modified by (i) using new data formats for processing data, (ii) applying new validation rules for the data, (iii) adding new metadata to the data to perform data enrichment, (iv) pruning data of datasets to enhance processing speeds, (v) performing data cleanup (e.g., (a) remove data errors, (b) remove duplicate data, (c) modify missing values in the data, and/or (d) perform any other data cleanup), (vi) reallocating computational resources (e.g., CPU, memory, network bandwidth, and/or any other computational resources) of the data processing system, (vii) prioritizing critical operations of the data processing system, (viii) adjusting communication protocols between the data processing system to reduce latency and/or improve reliability of the operations, (xi) enhancing system redundancy, etc.

The method may end following operation 312.

Thus, via the method shown in FIGS. 3A-3B, embodiments herein may likely improve a likelihood of managing the operation of the distributed system. By improving the likelihood of managing the operation of the distributed system, the distributed system may be more likely to provide desirable computer implemented services by, for example, using telemetry data and/or a current state drift to identify a predicted future state drift, using severity levels of the current state drift and/or the future state drift to select a remediation process, etc.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing an operation of a distributed system, the method comprising:
identifying an occurrence of a drift identification event for a data processing system of the distributed system;
based on the occurrence:
identifying, using at least telemetry data from the data processing system, a current state of the data processing system;
identifying, using at least the telemetry data and a trained machine learning model, a predicted future state of the data processing system;
performing, using the current state, the predicted future state, a blueprint used to manage the data processing system, and a drift schema, a drift identification process to ascertain whether the data processing system has and/or is likely to suffer a state drift at a future point in time;
in an instance of the performing where the data processing system has or is likely to suffer the state drift:
classifying, using the drift schema, a severity level for the state drift;
selecting, based on at least the severity level, a remediation process to mitigate impacts of the state drift; and
performing the remediation process to update operation of the data processing system to manage the impacts of the state drift on an ability of the data processing system to continue to provide desired computer implemented services.

2. The method of claim 1, wherein the blueprint comprises a set of parameters usable to manage the operation of the data processing system, and the set of the parameters, when used to manage the data processing system, cause the data processing system to provide the desired computer implemented services.

3. The method of claim 2, wherein the drift schema comprises a classification system for levels of severity of the state drift.

4. The method of claim 3, wherein the levels of severity of the state drift are based on differences between blueprints and states of the data processing systems that are managed using the blueprints.

5. The method of claim 4, wherein the set of the parameters indicate, in part, software to be hosted by the data processing system.

6. The method of claim 4, wherein the set of the parameters indicate, in part, configurations for software to be hosted by the data processing system and/or hardware components of the data processing system.

7. The method of claim 4, wherein the classification system comprises thresholds for the differences, and a rubric for classifying, based on the thresholds that are exceeded by the differences, the levels of the severity into one selected from a group consisting of:
a minor configuration drift;
a moderate configuration drift; and
a critical configuration drift.

8. The method of claim 1, wherein the predicted future state comprises at least one selected from a group consisting of:
performance metrics for the operation of the data processing system during, at least, the future point in the time;
resource utilization during the operation;
a security posture of the data processing system during the operation;
communication capabilities of the data processing system during the operation; and
a health status of the data processing system during the operation.

9. The method of claim 1, wherein selecting the remediation process comprises:
selecting, using the drift schema, at least one action to perform as part of the remediation process, the drift schema associating different actions with different severity levels of the state drift.

10. The method of claim 1, wherein performing the remediation process comprises:
modifying the operation of the data processing system to reduce the severity level for the state drift.

11. A non-transitory machine-readable medium having instructions stored therein, which when executed by a processor, cause the processor to perform operations for managing an operation of a distributed system, the operations comprising:
identifying an occurrence of a drift identification event for a data processing system of the distributed system;
based on the occurrence:
identifying, using at least telemetry data from the data processing system, a current state of the data processing system;
identifying, using at least the telemetry data and a trained machine learning model, a predicted future state of the data processing system;
performing, using the current state, the predicted future state, a blueprint used to manage the data processing system, and a drift schema, a drift identification process to ascertain whether the data processing system has and/or is likely to suffer a state drift at a future point in time;
in an instance of the performing where the data processing system has or is likely to suffer the state drift:
classifying, using the drift schema, a severity level for the state drift;
selecting, based on at least the severity level, a remediation process to mitigate impacts of the state drift; and
performing the remediation process to update operation of the data processing system to manage the impacts of the state drift on an ability of the data processing system to continue to provide desired computer implemented services.

12. The non-transitory machine-readable medium of claim 11, wherein the blueprint comprises a set of parameters usable to manage operation of the data processing system, and the set of the parameters, when used to manage the data processing system, cause the data processing system to provide the desired computer implemented services.

13. The non-transitory machine-readable medium of claim 12, wherein the drift schema comprises a classification system for levels of severity of the state drift.

14. The non-transitory machine-readable medium of claim 13, wherein the levels of severity of the state drift are based on differences between blueprints and states of the data processing systems that are managed using the blueprints.

15. The non-transitory machine-readable medium of claim 14, wherein the set of the parameters indicate, in part, software to be hosted by the data processing system.

16. A data processing system, comprising:
a processor; and
a memory coupled to the processor to store instructions, which when executed by the processor, cause the processor to perform operations managing an operation of a distributed system, the operations comprising:
identifying an occurrence of a drift identification event for the data processing system of the distributed system;
based on the occurrence:
identifying, using at least telemetry data from the data processing system, a current state of the data processing system;
identifying, using at least the telemetry data and a trained machine learning model, a predicted future state of the data processing system;
performing, using the current state, the predicted future state, a blueprint used to manage the data processing system, and a drift schema, a drift identification process to ascertain whether the data processing system has and/or is likely to suffer a state drift at a future point in time;
in an instance of the performing where the data processing system has or is likely to suffer the state drift:
classifying, using the drift schema, a severity level for the state drift;
selecting, based on at least the severity level, a remediation process to mitigate impacts of the state drift; and
performing the remediation process to update operation of the data processing system to manage the impacts of the state drift on an ability of the data processing system to continue to provide desired computer implemented services.

17. The data processing system of claim 16, wherein the blueprint comprises a set of parameters usable to manage operation of the data processing system, and the set of the parameters, when used to manage the data processing system, cause the data processing system to provide the desired computer implemented services.

18. The data processing system of claim 17, wherein the drift schema comprises a classification system for levels of severity of the state drift.

19. The data processing system of claim 18, wherein the levels of severity of the state drift are based on differences between blueprints and states of the data processing systems that are managed using the blueprints.

20. The data processing system of claim 19, wherein the set of the parameters indicate, in part, software to be hosted by the data processing system.
